(19) United States
(12) Patent Application Publication
(10) Pub. No.: US 2014/0169760 A1
(43) Pub. Date: Jun. 19, 2014

(54) Media Player with Recorder Optimization

(71) Applicant: Rembrandt 3D Corp, Ithaca, NY (US)

(72) Inventor: Stephen Blumenthal, Newfield, NY (US)

(73) Assignee: Rembrandt 3D Corp, Ithaca, NY (US)

(21) Appl. No.: 14/106,284

(22) Filed: Dec. 13, 2013

Related U.S. Application Data
(60) Provisional application No. 61/737,449, filed on Dec. 14, 2012.

(51) Int. Cl. G11B 27/34; H04N 9/87

(52) U.S. Cl. CPC G11B 27/34; H04N 9/87
USPC 386/241

(57) ABSTRACT

A method for creating depth image correction markers for a 3D depth mapping format for a 3D video program, especially useful with an Auto stereoscopic 3DTV, as well as a method of playing the 3D video programs using the correction markers.

### REFERENCE TO RELATED APPLICATIONS

This application claims one or more inventions which were disclosed in Provisional Application No. 61/737,449, filed Dec. 14, 2012, entitled “Auto Stereoscopic 3DTV Media Player with Depth Remote Control Customization”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of devices and methods for displaying 3D media.

2. Description of Related Art

Depth Image Based Rendering methods (DIBR) and 2D Plus Depth™ technology were developed by Royal Philips and Dimenco. These methods are comprised of features from prior art players such as the 3DSolutions Media Player, the WOWvx media player and the Dimenco Media Player.

Editing operations are performed on a frame by frame basis on an editing timeline provided by the Display Control Tool (DCT) software as developed by Philips and Dimenco in their WOWvx and @ Depth 3DTV Auto Stereoscopic 3D (AS3D) Display platforms. This data would be embedded in the header, video signal or code somewhere so that 3D TV Firmware reads the adjustment on a frame-by-frame basis (if needed) and manages the DCT automatic adjustments accordingly.

This software tool was originally designed by Philips and Dimenco as a static single setting Factor and Offset Control tool. Both of these elements are primarily important relative to the viewing environment and are designed to be set by the viewer as manually imported data, which is inserted via the Remote Control in the appropriate Media Player window. This information could be asked for from a number of menu screens as its data is part of the reference point for the Master Global settings of the DCT.

The DCT uses Factor and Offset settings to adjust the image. These will be referred to jointly in this discussion as “FnO”. As the Factor settings rise and fall from negative 100 to 0 to plus 100, the objects within the image field of view tend to increase or decrease the “visual pop” or separation in depth, while the Offset control operating on the DCT in a range of 0 to 200 with a 100 midpoint, adjusts the focal plane forward or backwards in the field of view, relative to the focus point of the screen plane. The DCT Factor and Offset both have default midpoint settings which are driven by the plus or minus value of the Master Global value reference point.

The key limitation of the Philips/Dimenco approach is that the one single Factor and Offset setting for the DCT, is for the entire clip. And therefore requires that to minimize the 3D video distortions, errors and artifacts found in each segment, that the settings must be lowered, or averaged downward in order to bring all the segments of the clip into a DCT range which is then able to be seen with a minimum of video distortion. This has the unfortunate effect of dramatically downgrading the quality of the AS3D image, resulting in a flat or almost 2d image level of 3D content.

This is a “one size fits all” approach, as the variations in 3D image quality found segment to segement are ignored, the 3D image quality variations found in the frame by frame images are ignored, and there is no mechanism to bring the DCT into a range that also allows for environmental issues such as lighting and screen location to be addressed, and therefore these aspects are also ignored.

The manner and order used in these prior art machines limited the operational performance of the overall machine's function.

FIGS. 8a and 8b show how the “2D Plus Depth format” represents a three-dimensional scene by combining a conventional two-dimensional video image (FIG. 8a) with a Depth Map (FIG. 8b), in which the depth of an object in the scene is represented by varying shades of gray, with white areas closer to the viewer and black areas further away (or vice versa). In the example, the flower is very close to the camera, hence the depth map shows it as white, and the sky is furthest away, hence the depth map shows it as black. The trees, at varying distances, are represented by differing shades of gray.

The depth map provides the 3D display hardware and software/firmware with the information needed to create the left eye and right eye views which in turn create a 3d stereoscopic effect on a TV. These can be displayed alternately and viewed through shutter glasses in conventional 3D TV systems, or, converted to multiple views on the screen—for example nine mutiviews—and viewed through a lenticular screen or LCD stripe filter, they can be viewed without glasses. Such systems are called “Auto-Stereoscopic 3D (AS3D) systems”, and each view in such systems creates a viewing “cone”, as illustrated in FIG. 7.

Viewing “Cones” each provide a slightly Different 3D perspective, as manipulated by the On board Firmware, which is rendered with every frame, and changed by the variations in the Factor and Offset Controls of the Display Control Tool (DCT).

FIG. 9 shows how the 2D Plus Depth format is used. The video input 91 has the 2D image 93 and depth map 92. The rendering hardware/software 94 converts the 2D image 93 and depth map 92 into nine different views 95a . . . 95h. These views are then interweaved 96 and rendered in real-time on display 97.

2D-plus-Depth=2D+Depth=2D+Z=image+depth=RGBD=RGBZ

In a basic approach, depth is encoded as auxiliary video stream, in which the luminance of the video stream carries depth information. Preferably, 256 levels of greyscale will build a smooth gradient of depth. Using this approach, there is a limited bandwidth increase compared to regular 2D video—the compressed greyscale increases bandwidth by about 5-20%. The system can be used with existing distribution infrastructure, offers flexibility and compatibility with existing production equipment and compression tools and allows applications to use different 3D display screen sizes and designs in the same system. This 3D format is standardized in MPEG, supported by major CE companies.

Prior art hardware systems include 3D Solutions Media Player, an AS3D media player designed to play the .s3d video format created by Philips for the purpose of playing and reading the depth map information required for the 3D AS3D playback on the AS3D LCD panel.

The WOWvx Media Player was the second player in the original Philips development by 3D Solutions, the Philips Incubator company. Philips shut down the incubator in 2009, and it became the company now known as Dimenco, utilizing all of the Philips developments in both hardware and software and is now the representative company for the pHilips as 3d products. The Wowvx player added features to the 3D Solutions Media Player.

The Dimenco Media Player, is the third evolution in media players developed by the Philips spin off, Dimenco, for the purpose of upgrading the 3DTV AS3D technology platform.

“Visual Pop” is the element of spatial separation between objects in a 3d stereoscopic field of view. The more the “pop”, the greater the degree of separation between objects, and the easier it is to perceive the 3d effect on a 2d LCD screen.

### SUMMARY OF THE INVENTION

The method provides for a means to customize the DCT Factor and Offset for the clip, for the individual segments, for the frame by frame correction, and supports an environmental adjustment in response to lighting, location, and other factors.

This new R3D Recording Media Player method sets a Master Global marker for Factor and Offset which is the base adjustment for the entire clip, a Major Factor and

Offset DCT adjustment which can be changed for each segment of x number of frames of the clip (and thereby operates to provide a correction adjustment that works well for both the entire clip, each segment), and a Minor Factor and Offset adjustment of the DCT which corrects for the individual frame by frame distortions.

The value of this customized approach is that it supports optimal 3D AS3D image quality for the entire video, as the DCT is customized to provide the “correct ” AS3D setting for each and every substantial change in 3D depth of the image quality.

### BRIEF DESCRIPTION OF THE DRAWING

FIG. 1 shows the Customer Media Player Window of the Media Player.

FIG. 2 shows the Editor/Recorder Media Recorder Window of the Media Player

FIG. 3 shows the “Tools and ON Site” Media Player Media Tools Window of the Media Player.

FIG. 4 shows /Remote interface OSD Remote Control.

FIG. 5 shows the Scheduler Menu Window of the Media Player.

FIG. 6 shows a block diagram of the video editing system

FIG. 7 is a prior art diagram of a user watching 3D content on an AS3D system.

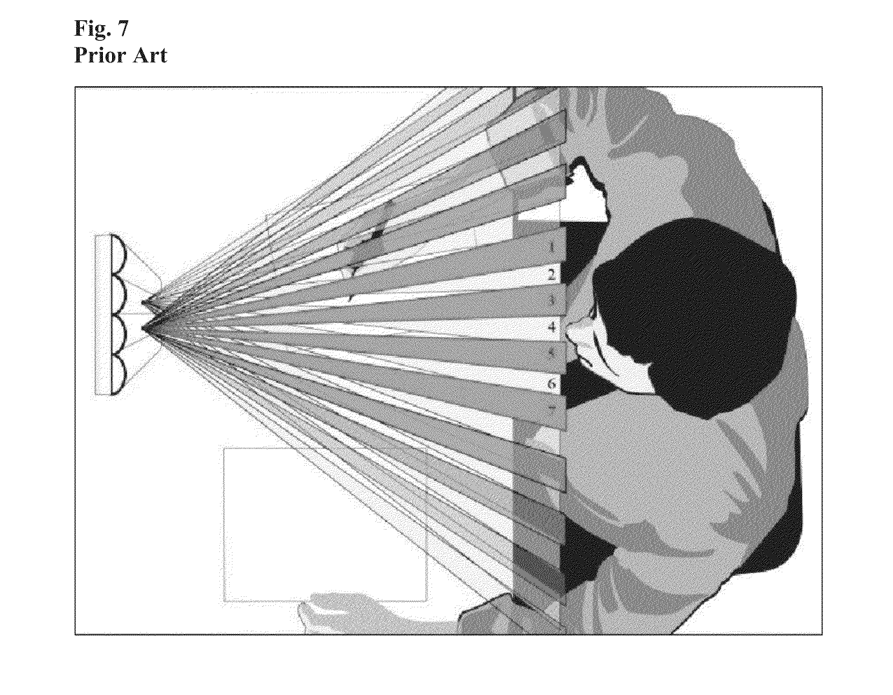

FIGS. 8a and 8b show the 2D image and depth map, respectively, as would be used in a 2D-plus-depth-map AS3D system.

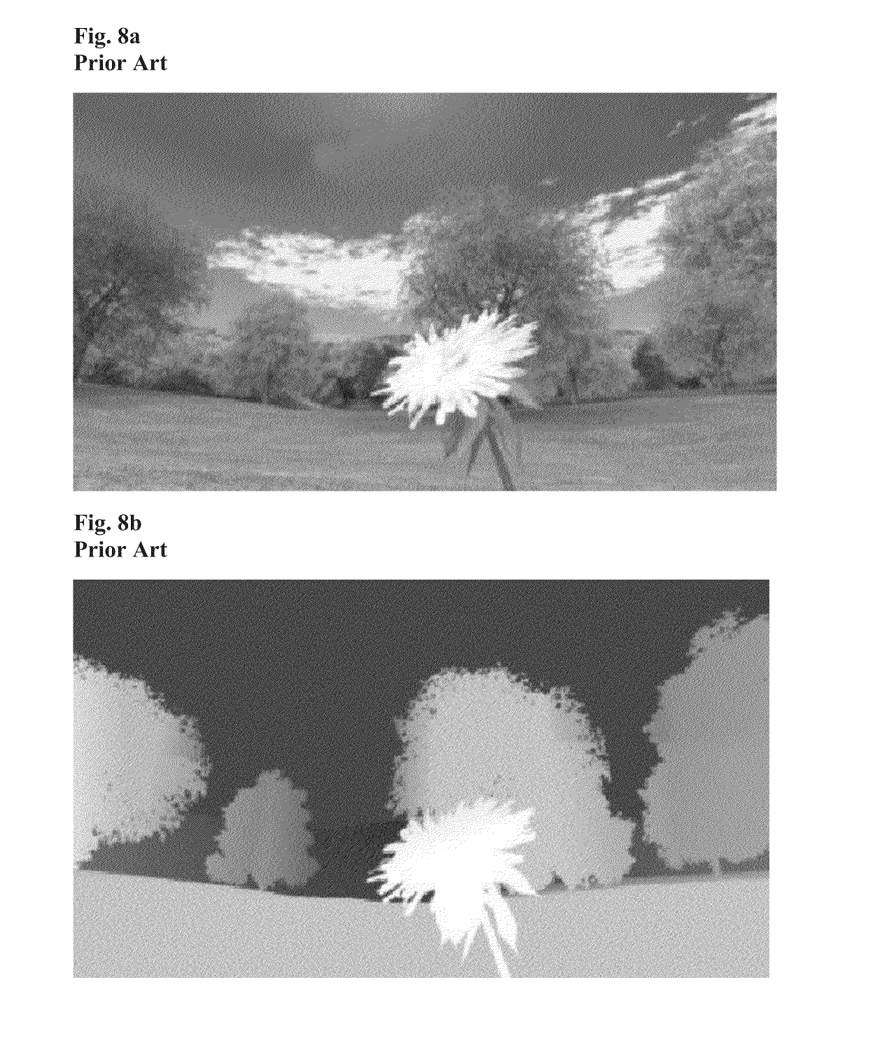

FIG. 9 shows a block diagram of a prior art AS3D system.

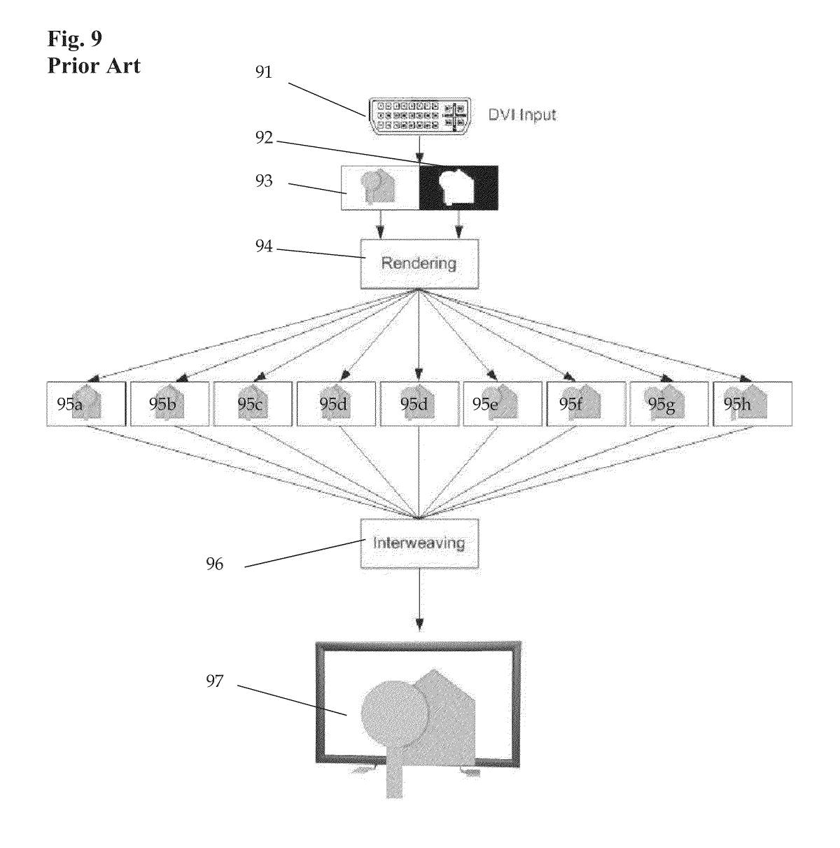

### DETAILED DESCRIPTION OF THE INVENTION

The R3D system presents a novel method for creating depth image correction markers for a 3D depth mapping format, especially useful with an Auto stereoscopic 3DTV.

The method provides the Operator with a means whereby he is able to create a permanent correction marker as a XML software file, utilizing Display Control Tools (DCT) which are termed, “Factor” and “Offset”, “View Direct”, and “Viewing Distance”. This permits the operator to make live, real time, on the fly, adjustments to the 3D image quality, while the operator is looking at the 3D image, and provides the operator with a method to make corrections based on the operator's visual assessment of the 3D quality and to make decisions as to the optimization of the image quality, which are translated into permanent Markers by manipulating the Factor and Offset Slider controls of the Record Media player, whose adjustment is connected to the DCT tools. The markers are saved as XML data associated with a video file. When the video file is played back, the markers are used in coordination with the 3D images to adjust the Factor and Offset to customize the DCT for Playback which corrects for environmental factors such as lighting, height of screen, angle of viewing distant, and other factors.

The DCT can thus be customized for Playback which corrects for underlying video distortions which are consistent throughout the entire clip, for example dark lighting, also for correcting changes in the 3D content responsible for errors on a segment by segment basis, which may include 30 frames or 500 frames of corrected DCT settings, and for correcting changes in the 3D content responsible for errors on a frame by frame basis.

The configuration of the DCT tools, in the various Media Player Windows, are combined in such a manner as to support a R3D accelerated work flow which permits the position of the various controls and their new functionality be accessed to support a sequence of operations that results in a more refined, higher quality 3D As3D image.

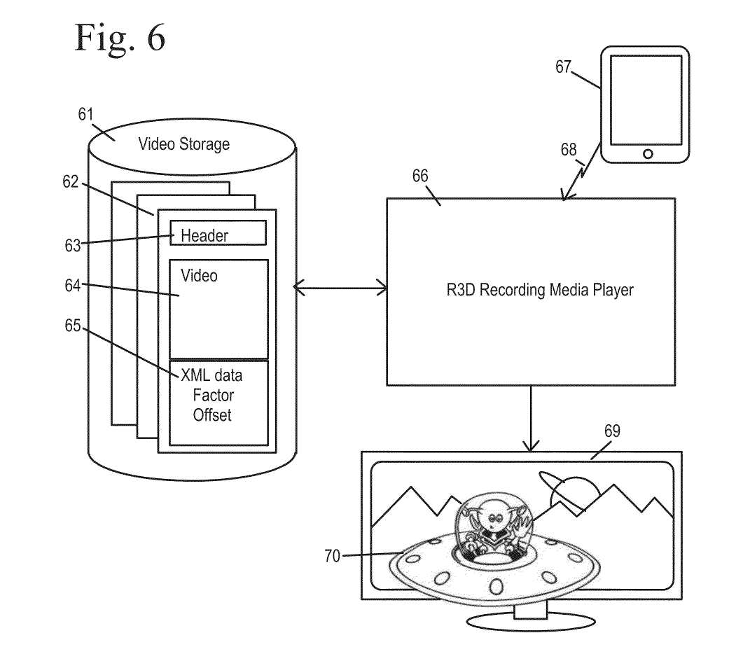

Referring to FIG. 6, the Rembrandt 3D (R3D) invention presents an all-in-one, 3DTV Software media player 66 which is designed to insert and record video 3D Markers into 3D video programs stored as video files 62 on a video storage device 61 of any convenient type in an XML file format 65. The XML data 65 created by the Recording Media Player 66 are accessed along with the RGB video content 64. The video files 62 may also have headers 63 which can contain information about the overall video presentation, including Master Global adjustments as will be explained below. The player is designed to correct and optimize 3D AS3D images 70, operating on 3D televisions 69, preferably of the Auto Stereoscopic (AS3D) type, utilizing the Depth Image Based Rendering methods (DIBR) and 2D Plus Depth™ technology developed by Royal Philips and Dimenco. A remote control 67 allows convenient adjustment of parameters in the windows of the player 66, as will be discussed below.

The R3D Media Player 66 provides the additional ability to record and playback on the fly corrected Factor and Offset adjustments, (as either a manual, automatic or semi-automatic operations) performed on a frame by frame basis, on the editing timeline provided by the Display Control Tool (DCT) as developed by Philips and Dimenco.

The R3D Media Player 66 recombines these in a form which has much higher performance capacity, and because it operates at a higher level of performance, some additional R3D features are available to fine tune or optimize this new level of performance.

The additional 3 or 4 levels of the Factor and Offset adjustments in the DCT, as opposed to Original DCT single level of adjustment, upgrades the image quality by supporting customization of the clip based on environmental factors (1), the whole clip (2), the individual segments (3), and on a frame by frame basis (4), that compose the segments. The environmental adjustments are often not needed.

These additional features are found in The Record/Editing Window of the R3D

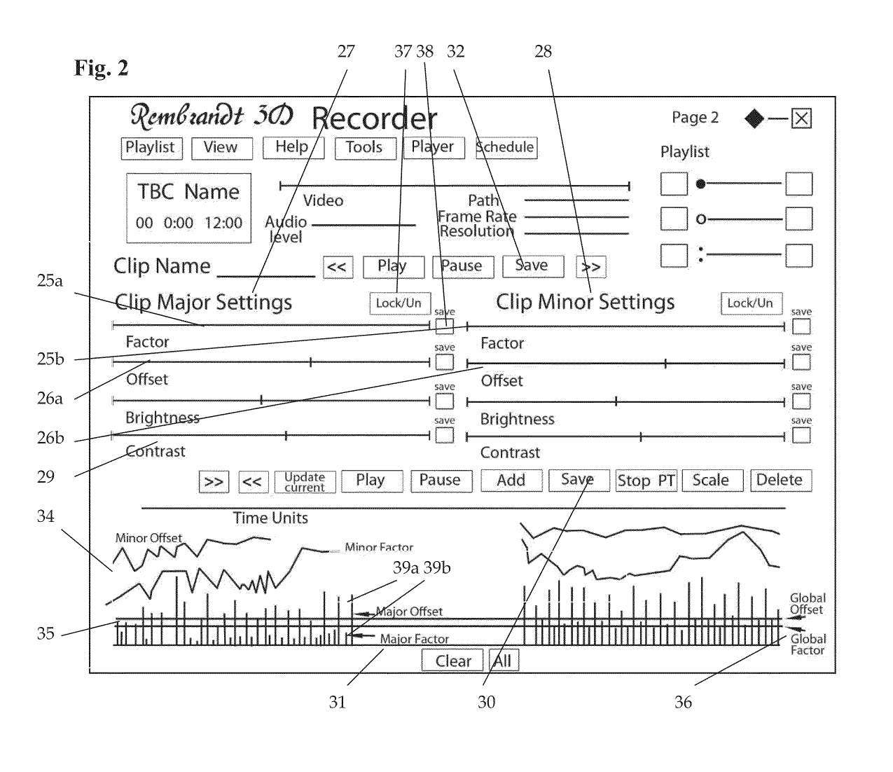

Media Player (FIG. 2), which will be discussed in more detail below. This upgrade is accomplished by an operator, looking at the clip and based on his perception of 3D Depth in the content 70, as seen on the AS3D screen 69, making an XML file 65 listing all of the new recording Factor and Offset settings, which are now Markers, located in the XML file 65 timeline and corresponding to the frame and segment of the video file 64 being played back. Once the markers are set, the video file 62, with the updated header 63, video 64 and XML data 65, can then be saved back to the video storage 61.

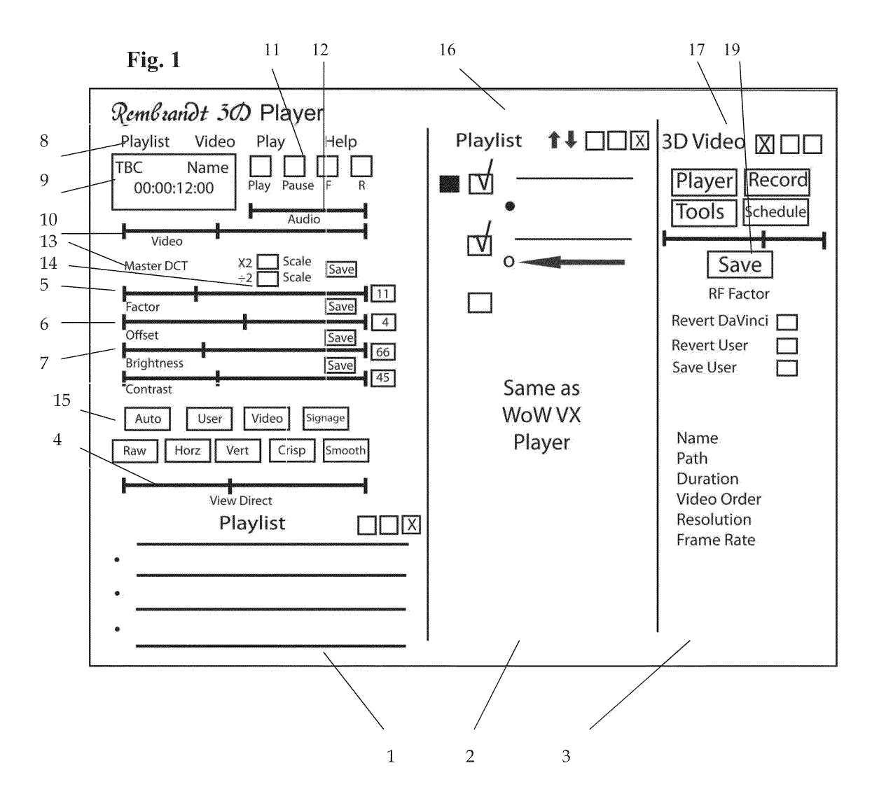

The Rembrandt 3D Maestro™ media player 66 is designed to have five major window segments and a number of subset windows. The major segments are the Customer Media Player shown in FIG. 1, the Editor/Recorder Media Recorder shown in FIG. 2, the

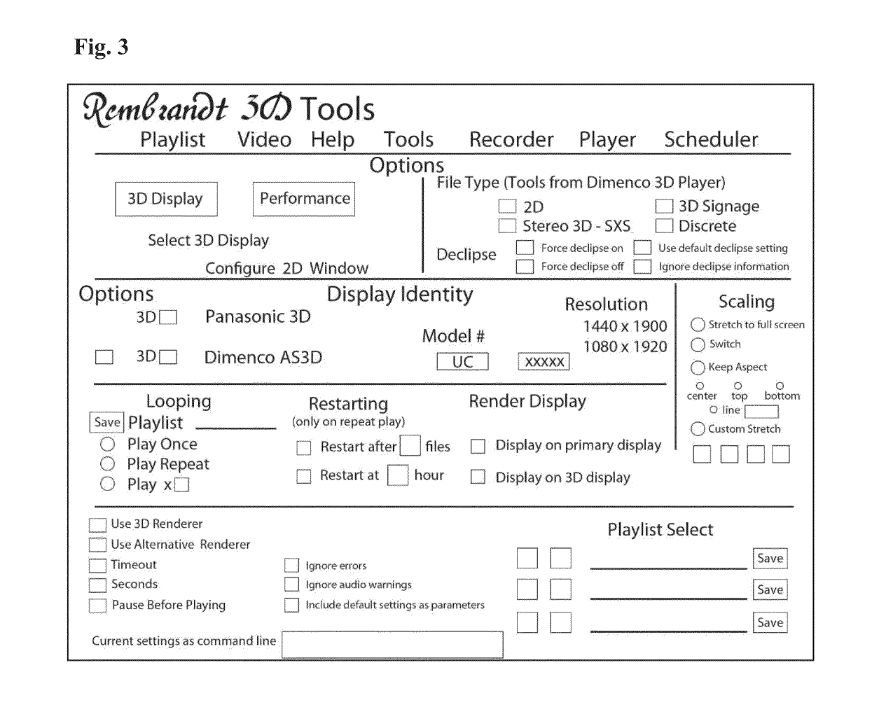

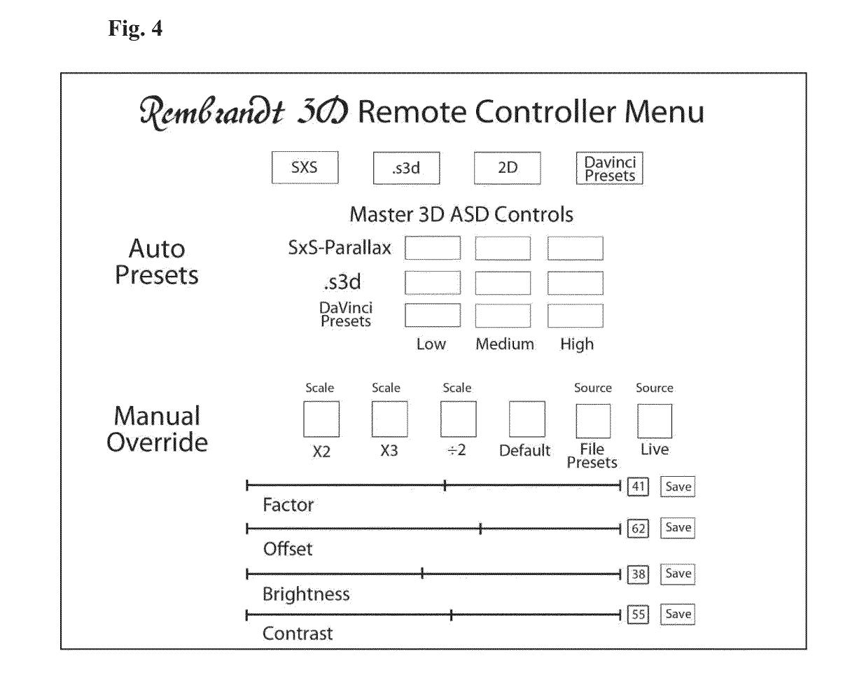

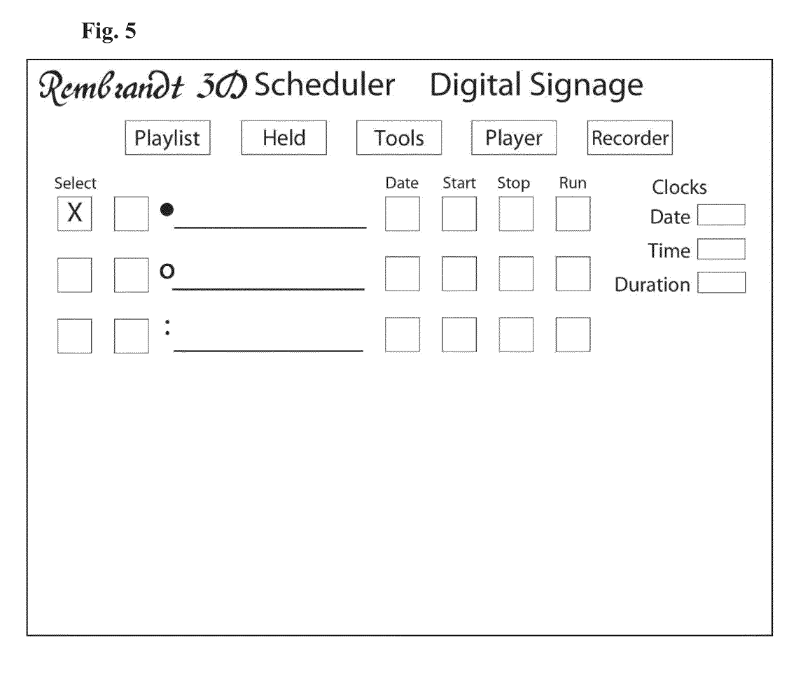

“Tools and ON Site” Media Player Media Tools shown in FIG. 3, the Remote interface OSD Remote Control shown in FIG. 4, and the Scheduler Menu shown in FIG. 5.

### Overview of each of the five windows

### Customer Media Player Window

The Customer Media Player (see FIG. 1) is for AS3D Playback functions and for the Remote Control of “on screen” Factor/Offset adjustments which are calibrated to 3 scales (AUTOMATIC, SEMI AUTOMATIC AND MANUAL). This Player has the general look of the Philips WOWvx player with 3 separate panes 1, 2 and 3, and similar locations for all elements in the first, second and third pane.

Some elements of the Dimenco DCT would be added to the Customer media Player, such as View Direct 4 enabling playback, located in first pane 1 under Play controls and audio level adjust.

View Direct 4 is a window setting which requires that the end user enter a value, or make a slider control adjustment/decision based on his observation of the screen image 3D quality, and by moving the slider control, adjusts the image to his personal preference or environmental limitations, hence the use of the remote. These adjustments are a base line for the DCT control settings and are a first step in setting up the AS3D playback for perfect picture.

The Media player window of FIG. 1 is primarily a Playback menu for all clips which have already been R3D mastered with the XML markers pre-recorded by off line operators, who have used the Recording Media Player window to achieve the Factor and Offset settings, which are recorded onto the XML file as an onboard traveling adjustment which is played back with the RGB video/depth map, and from the XML file the Factor and Offset adjustments are changed based on the marker setting which corrects the depth map errors in the clip. This playback method requires no or with minimal user controls.

This Window has two slider bars 5 and 6 for FnO adjustments for Master Global DCT factor and Offset settings for AS3D Screen (most likely located in the first pane 1 where the Factor (and 2D Video check box is), and two slider controls 7 for brightness and contrast settings for Master Global settings of screen.

These new Markers which are a Factor and Offset correction to the original depth map as it is being played, is an upgrade from the Philips and Dimenco method of providing one Factor setting, and one Offset Setting, and one Direct View Setting, and one Viewing Distance setting for the entire clip.

As an example, if we are correcting and optimizing a science fiction film showing alien flying saucers on a distant moon, perhaps 70% of the content is in dark, night, outer space or other low light visuals. The Master Global Factor 5 and Offset 6 setting would address this level of 3D imagery for optimized 3D effect.

The Player Window is divided in to three vertical panes, and combines is a rearrangement of the Wow player position of controls with the introduction of the DCT controls as Master Global adjustments. Master Global adjustments for the DCT are set for the model of the AS3D Dimenco Screen and make DCT adjustments for the environment and are meant as an End User interface allowing an override level of control which augments the Major and Minor DCT controls.

The DCT functions on the Player are designed to also serve as an On Screen Display Window to support the software needed for the 3DTV Remote Control, hand held operation. It is the Window that is opened when the Remote interface is activated.

The DCT operations on the Player window are limited to setting a base level of FnO impact on the clips which have pre-set Rembrandt 3D settings. These are clips which will show in the Playlist middle window as having a red dot highlighted below the title of the clip. Whenever an XML file has been created by the operator in the Recorder player, a small circle will appear under the title of the clip.

When clicked on, the circle goes from clear to red. The XML will be activated as a playback guide for the FnO, and the circle will turn RED. When not activated, the circle will remain an outline. No circle means that the clip has not had any setting recorded, and therefore the DCT on the Player window is the main activator of the FnO for the clip.

The Player Window is designed to afford the End User a number of key functions which are limited to the playback of 3D. These include the ability to manage the Playlist, activate the Remote control window to set FnO for personal viewing comfort and to be able to switch from pre-recorded “canned” PC content to web based or STB sourced “live” 3D side by side content, for “on-the-fly” auto conversion via a “3D enabler”.

Starting with the left vertical Pane at the top, we see the buttons, “Playlist, Video, Play, Help” 8. These buttons have a pull down menu structure.

Below these is the TBC window 9 showing timecode, name of clip. Next to the TBC box is the control bar 10 for video playback, four boxes 11 for “Play, Pause, Fast For, Reverse,” Under these boxes is located the Audio Level bar 12 for sound, and below that is the Video playback time line, indicating the position of the clip relative to its duration.

Master Global DCT or “Master DCT” 13 as it is labeled on the page, is the section, which allows the End User to manipulate “limited” DCT operations. This control is ganged to the to the Major/Minor Recorder controls, which are a one position setting for the clip, in which case these two controls are tied together and provide a cumulative effect on the DCT.

Next to the Master DCT title, to right are two “Scale” boxes, and a “Save” box 14. The purpose of these boxes when selected is to change the scale of the DCT operation. This choice allows the end user to change the Scale up or down, for the adjustments on the DCT FnO level line.

Times 2, (X2) would increase the scale to double its number of increments, permitting a greater degree of “ fine tuning” of the clip. Divide by 2 would shrink the scale by number of units, and allow a small adjustment to have a major effect. If neither box is checked, then the DCT scale defaults to the original scale as set by the DCT original player. Below the DCT controls are the Auto, User Video, Signage buttons, which have the same function and purpose as on the WOW player. Beneath these controls are the Smooth, Raw, and View Direct Controls. These are from the DCT Advanced second window and can be positioned as is convenient.

The position of the “Smooth” and “Raw” controls are in this area 15. The Playlist at the bottom of the Window is the same as in the Wow player and should be capable to perform all functions. This completes the description for the 1st left pane.

The center pane 16, 2nd position, is the location of the Playlist, allows additions, deletions, arrangement, etc.

The Red dot under the title line of the clip on the Playlist, as seen in the arrow on the diagram is the indicator that the clip has access to an embedded XML of settings which are able to be played back as the clip is running, and make the FnO adjustments as previously set. As mentioned earlier, the dot is green when settings are on, is hollow or circular when they are off, but accessible, and no Dot appears when the clip has not been remastered with FnO settings.

The third pane 17, right side position of FIG. 1, is based on the Wow player though with the addition of the four selection boxes, Player, Record, Tools, Scheduler, indicating which Player window can be ‘jumped’ too. These are links for the other windows, and may be better located somewhere else on the top section.

These buttons would only be functional for End Users who were content creators or managers and most End Users would not have any need to have access to the other windows. Therefore I located them on the side upper corner.

RF Factor slide controller for making adjustments would only be activated to fine tune individual clips. For clips with embedded FnO adjustments it would provide a “fourth” factor adjustment, on top of the others and mitigate the image quality. It would impact the Major FnO as an adjustment for the entire clip and not impact directly the

Minor FnO. In the event that the clip has no XML file embedded, than the RF Factor adjustment becomes the only second level tuning adjustment available. Like the Wow player, the adjustment to the clip of the RF setting is accomplished when the Clip title in the Playlist is shadow boxed and playing, then the RF adjust is recorded to the clip.

### Editor/Recorder Media Player

As shown in FIG. 2, this is the second Window and is the Window which embodies the new invention as a feature and function upgrade over the former Philips/Dimenco Media Players.

The Recorder Window permits the dynamic insertion of the FnO settings for playback and provides the ability to watch the 3D screen, stop the clip, make FnO adjustments on the Major and Minor FnO sliders, and hit save, and have the settings logged into the moving time line, graphical editor window at the bottom of the page. Not shown on the Diagram of the Recorder Window, in the bottom graph of FnO settings, is the Red vertical marker, which travels with the clip as the segments are playing. It should run top to bottom of the graph, with a red dot indicating the position of the marker on the FnO settings. The marker travels as the clip plays and indicates the position of the insertion. Description of the Recorder Window Diagram Starting at the upper left corner, the first row top left are the command buttons, Playlist, View, Help, Tools, Player, Schedule, these are a combination of the Player controls and the link buttons to the other windows.

Further to the right is the box with the Playlist short version showing 3 or 4 of the clips listed in the playlist from The Player window. This allows access to moving via scrolling the Playlist down to open other clips without going back to the Player menu.

The clips in this playlist show all the same elements as the Playlist middle pane in the Player window, with the additional aspect that once a clip is selected on this Recorder window, from this playlist, the clip will need to Repeat Play, not going to the next clip in the Playlist, as is the case with the Player window. Clips selected from this window repeat until the next clip is chosen.

The red arrow cursor shows while the clip is playing, the check box to “enable” the clip is next to the picture box of the clip first image, the clip title line, and the gray shading indicating that the clip is being FnO set. Also is the new Red DOT, which indicates that the clip is embedded with FnO adjustments, as, indicated earlier.

Red means the FnO settings are active and playing, and can be seen in the bottom graph as the Red marker travels the length of the time line. An open O no red, means that the clip has settings but that they are turned off and inactive. And no O means that the clip has not had any setting yet and will be executed with new settings or for some reason no setting is wanted, and the only FnO adjustments would be made from the Player and the Master Global FnO adjustments.

Next Row Down, the box for the TBC indictor, name of clip. Next in the row is the Video line, below that the Audio level indicator, to the right, the Path, Res, frame rate information which comes up automatically when the clip is selected from the Playlist. Below this row is the Clip Name line, then the Player controls, reverse <<, Play, Pause, Save, and Forward >>,

Next Row down is the Clip Major Settings 27, and the Clip Minor settings 28. These two boxes are the controls for setting the two additional FnO adjustments after the Master Global FnO has been set for the screen and environment.

In the event that the Major control is reset during a clip, a movie for example, then a SAVE button would be activated from the Major Recorder window at the point that the Major setting changed, but then the Master Global adjustments would remain the same, and the Major adjustments operate in addition to the Master Global adjustments.

By changing the Major in the middle of a clip and saving the change, this would activate a disconnect from the Master Global which remains constant, and the Major which now is at a different level of FnO. The Minor DCT controls as part of the “Recorder” player function, remains unchanged as far as the settings, though it is impacted as a result of the Major and Master Global positions.

The Major FnO settings 27 add to the Global DCT as a fine tuning of the settings. The Minor control adjustment 28 runs as a separate FnO setting and is part of the signal path directly. The point is that there are two separate paths to influence and set the FnO controls.

It is in this window that the DCT controls of Factor 25a 25b and Offset 26a 26b are manually set via Keyboard or Remote control, and embedded in the clip as an XML file listing the Factor and Offset changes per Major 27 and Minor 28 DCT changes. The information from this XML file is embedded in the header code to be invisible and automatically activated by the Player and seamlessly transferred with the clip when it is downloaded to another PC for playback.

This stage of the R3D Maestro™ is an important stage in our 3D image optimization process. This Window would show a Recording FnO clip timeline 31 at the bottom of the window, where a marker travels across a horizontal time scale indicating the seconds and frames. It is called the Graphical Timeline Editing display.

Returning to the flying saucer example, in scenes or segments which take place outside on the moon in bright sunlight, the Major Factor 25a and Offset 26a DCT would be custom set to address this level of image quality, and the Minor Factor 25b and Offset 26b DCT operation would take into account adjustments required to give optimal image quality to close up shots which might require a different Factor and Offset DCT setting from the long or wide shots.

All of these adjustments are set based on an operator's personal taste as to the level of 3D quality he is seeing in the 3D content 70 on the AS3D screen 69. These adjustments are similar to Color Correction adjustments found in video Post Production editing.

The Correction of blurred, doubled, or torn 3D images, and Optimization of the 3D depth spatial relationships are achieved by the Recording/Edit window by changing the Factor 25a 25b and Offset 26a 26b settings there by increasing the parallax, and manipulating other elements of focus of the 3D image on the screen.

The logic here is as follows:

As the clip 62 is playing the tech is looking at the 3D screen 69. He has already set the Master Global FnO factors (4, 5, 6, 7 in FIG. 1) for the overall compromised settings for the entire clip based on the site where the display will be located.

Now as the clip is playing, he sees ghosting or severe cones, and seeks to move the focus plane to where the action is. To accomplish this, he pauses the image, goes to the Major Factor slider control 25a located on the left side of the 1st pane 27 (see FIG. 2) and makes an adjustment. He does the same with the Offset slider 26a, and Brightness and Contrast 29 if needed. The guidance for this adjustment is based on eliminating the Major artifacts of the clip.

This is the base line adjustment for the entire clip, or for individual segments, depending upon the clip duration and if there are any Master Global DCT adjustments set in the window of FIG. 1. This institutes a base line for the Major FnO adjustment 27 to be added. He then clicks on the “SAVE” Major button 30 which places two markers 39a 39b on the clip horizontal time line 31. The settings are recorded in the storage 61 as XML data 65 associated with the video 64.

This XML data 65 is later used while the clip 64 is playing, calling up and applying the dynamic FnO settings created by this editing to the video 70 being played.

The Minor adjustment 28 is designed to correct minor artifacts and smooth cone transitions, depending upon the speed of the action in the segment, by adjusting the Minor Factor 25b and Minor Offset 26b sliders. Once the Master Global and Major FnO settings 5 and 6 are recorded, the user then has a few choices as to how he will proceed in installing the Minor Clip settings for Frame by Frame correction.

The easiest and quickest option is to run the clip and pause it at every key frame transition (first marker in each shot of the program). The Director will place an FnO marker at each key frame juncture and on the second pass come back and “dial in” the FnO for the settings needed to clean up that segment.

A second option is to proceed on a time line basis, stopping every second as the image proceeds down the time line for point to point FnO settings. This feature of the Record screen requires a time line which can be scaled either to seconds as the smallest time units, or as seconds with 30 frames per second visible in the time line for split second changes in image action for super fast shots. A third option is to provide a time line scale which can be flexible in adapting the time units to numbers of seconds per division, as in 3 or 5 second units of 90 or 150 frames per time section, allowing the user to scale the time line to adapt to his content. This feature should have a “stop at every point” option which pauses the image at every second allowing the use to place a setting using the FnO sliders 25a/25b/26a/26b or skip it. These points would be auto stopped. An Auto stop could be of use for the 30 frames per second settings. Experience indicates that in many videos there are jump shots of 20 seconds that need a separate FnO from the preceding or next segment.

This scaling of the time line should allow for both 30 frames per second embedding, and offer a separate scale for stopping the clip at every “key frame” as identified either by a manual method or by an automatic software method if one is available similar to BBox key frame identification.

Application of the Record Window requires that as a first pass the user runs the clip and marks all the key frames, with a key frame marker. He may accomplish this by viewing the clip and setting a frame marker point at every key frame change, and then go back and make the accurate settings per marker set by the frame marker point. These changes are embedded and when played back, the time line “stop at every point” control would be activated to control this function. These stop point controls all have overrides or “off” buttons so that the clip may run without interruption.

Once all the key frames or the “stop points” are established, the Director proceeds with the Minor FnO embedding using the Minor controls 28. Every time a key frame changes, or a segment shifts from near to far, or other visual changes which require a new FnO setting to max out the image quality, the user pauses the clip, makes the new adjustment using the sliders 28 and saves it as a permanent setting.

This setting is now recorded on the Video time line 31, and seen as separate Minor FnO setting on the time line 34, from the recording of the Major 35 and Master Global 36 settings. Master Global settings 36 may only be changed in the timeline throughout the duration of the clip from the Player menu (FIG. 1), and are saved as mid-clip change by a special Master Global “Save” button 19 in FIG. 1.

This box has four active sliders. They are “Unlocked” or “locked” by clicking on the Lock box 37 to the right of the Major settings label. Once unlocked the Factor 25a, offset 26a, brightness and contrast 27 may all be adjusted as the FnO for either the entire clip, or for segments of the clip. Generally the Major FnO will be for the whole clip. But in movie cases it is possible that the Major settings will change 4 to 10 times during the 90 minute movie, whereas the Master Global controls do not change, and the Minor controls may show a new FnO every 100 frames or 3 to 4 seconds.

At the end of the FnO sliders is a “Save” button 38, below the save box is the numerical value of the setting, when the Save button is clicked after the setting is changed, it saves the setting for the duration of the clip or until it is changed again. The logic of having the save box 38 for each slider 25a 25b 26a 26b 29, as well as having a master save 32 in the line above and in the line below the FnO 30, is that depending upon the operation, it is quicker and easier to access the Save from a number of different locations. Also the slider save 37 only saves the one slider adjustment, whereas the other Save buttons 30 32 save the settings for both the Major and Minor FnO.

Each time a Save button is hit the FnO or adjustment is recorded on the FnO timeline graphic display 35 at the bottom of the page.

The Minor Setting Slider Controls 28 operate on the same basis as the Major controls 27 except that they are able to be embedded in the clip, the FnO settings can occur numerous times per clip segment. Some clips running 60 seconds, 1800 frames could have 200 plus setting points, where Factor and Offset, or one or the other of them has been set as a change from the last position.

On the Recorder screen, a live 2D window may appear, showing on both the 2D PC Control screen and on the AS3D screen a live image of the clip playing, showing the break up of the two fields. The video image can be shown on the left, live, and the 2D Plus Depth map image on the right, with the ability to switch the screen window to the 2D Plus Depth.

A depth map image only selection appears which allows the user to see the impact of his adjustments on the 2D Plus Depth map image, both in 2D and in 3D, Live.

The Graphical Time Line FnO Display 25—This graph shows in real time the positions of all of the FnO controls. As the clip progresses, a vertical red line marker travels the length of the time line indicating the position of the clip on the screen relative to the position on the time line.

The Graphical time line allows the 3D Editor to make adjustments to the FnO on a number of different levels, achieving a variety of solutions. This permits the Editor looking at the 3D display image and the 2D depth map with the Graphical time line can make judgment calls, live on-the-fly, based on the image quality.

He can for example adjust the transitional depth settings between key frames and segment shifts where depth perspective changes dramatically. He can keep an EYE to the next transition coming up, by observing on the Graph the positions of the FnO settings and can then modify the position of the FnO setting, update it, to take into account the next ‘radical’ depth FnO change and “smooth” out the transitions by inserting a midpoint FnO setting that allows the eye time to adjust between settings and segments.

Using these settings permits “data point strategies” to be developed which are arrangements of FnO insertions that provide specific corrections to the 3D image quality. In many cases this allows a user to “massage” additional depth and pop out of the 3D effect by going back to the Blue Box and redoing a number of depth maps. By taking advantage of the range of our FnO adjustments, married to the new up scaled Depth Map, we see that by making the adjustments on the FnO, we can dramatically improve the image quality. Once we have identified the FnO range based on Depth Map testing, we can then go back and “exaggerate” and amplify the depth map values to achieve substantially more separation between objects screen back, and objects in the foreground needing more forward pop impact.

For example, say we move a foreground object located at 230 white up to a 255 white because we can “dial” down the distortions and artifacts, balance the screen back transitions and cones by a combination of depth map “tricks” and number of FnO Data point insertions.

This type of “fine tuning” can give us a 20% to 30% improvement to the depth. By using the FnO tools in this manner we are able to up scale the depth map at the clips point of greatest depth visual impact, and control it with the Minor settings so that when the next segment of lesser depth impact appears, the controls can be adjusted to compensate for the changes in depth image quality. The Graphical FnO displays shows all three of the FnO control packages. The Master Global FnO settings are recorded as a line at the bottom of the graph. As they are settings for the screen based on the environment. One line for Factor, One for Offset, and one each for Brightness and Contrast. (not shown)

The Major FnO settings are seen as lines emerging from the base of the graph, one line for Factor and One line for Offset. We position these lines as vertical and show the Offset as Half the size and length as the Factor, though they are scaled the same. The

Minor fnO controls are the horizontal lines, one line for each control, and they run the length of the time line.

Buttons for The Graphical Time Line FnO Display
a) The “Update Current Button” in the tool bar is designed to allow the Editor to go back to a clip which is already been mastered with the FnO settings and by Pause the clip and clicking on the Current update Button, he is able to change the setting of the previously recorded settings and then click “Save”, to record the new setting.
b) Play, Pause, <</>>are all standard controls.
c) Save, records the FnO points for the clip at Red Vertical Marker time mark.
d) Add—This button is clicked to Add an FnO point to the Time line. The Editor watching the 3Dtv hits pause to stop the clip at the point where he wants to make an FnO change. He clicks Add, the slider controls highlight for the Minor controls, he adjusts the Minor Sliders, hits save, and then Play. He does not have to unlock the Minor controls, but does have to click Add to activate the new FnO settings for recording.
e) Stop Pt—button controls the advancement of the Clip Edit Marker, which is the Red line vertical marker that travels the length of the time line as the clip is playing. Stop Pt when selected stops the marker at every point on the time line. These may pre selected points manually, key frame points selected by the software as in the Bbox, or they may be time based markers stopping at every second, every 2 seconds, very 3 seconds, automatically. The Button box is divided into two sections. The first is the click on Stop Point that brings up a menu box selecting the choices for the Stop Point, as listed prior.
f) Scale button—The purpose of the Scale button is to allow the Editor to change the scale and range of the timeline to accommodate a variety of clip durations. This control allows the clip to be scaled to different time durations to accommodate a 90-minute movie or 90-second clip, to be visible within in the same space.
g) Delete button—this command Deletes the FnO point which have been selected by the Pause of the Clip Red Vertical Marker. Wherever the vertical marker is Paused, the FnO settings are for that data point. Delete removes that data point FnO.
h) Clear—is the button to erase the entire settings for the clip.
i) All—A new Button for Saving a clip settings needs to be added for specific 2nd and 3rd adjustments of FnO without altering the original Clip XML file of FnO settings, for say different size screens. This Duplicate Clip and XML file button would create a new clip name and XmL file to be changed and updated by the new Settings without changing the original file.

### The “Tools and ON Site” Media Player Window

Referring to FIG. 3, this is a window comprised of functions from Media players, including basic functions, plus items from a “Tools” menu, which opens to “Options”, and windows that pop up following this selection. Preferably, all of these Tools controls, button and slider controls should be visible from one window.

The “Tools” controls reflect the adjustments needed for addressing specific issues of content, user preferences and the location for the installation. Whether it be in a bar, casino or in a mall, the player needs to be able to correct for issues including environmental ones with controls that are easily adjustable by the B2B end user.

These Tool controls would all be on the Tools menu which is separate from the Player and Recorder menu. Access may be password restricted, if desired, for use by commercial accounts only. This reflects these controls being those which are more dedicated to solving issues in commercial environments.

The “Tools” Media Player window holds all the key controls and adjustments that support a variety of additional functions and operations. The top row of the window are the link buttons to the various other windows. The Tools/Options button opens the “Options” window from that player,

Second Row: Options window opens and shows the 3D Display and Performance Windows which open below and to the left. This is where the choice of monitors, configuration, and all of the windows for Stereo, view distance, from the Dimenco and 3DSolution Player.

Third Row—Master Global Settings, from the 3DSolutions Media Player, Play once, play forever, etc. Scaling,- switch, keep aspect ratio, are controls from 3DSolutions Player, same.

Fourth Row—Use Alternative—. Time out, seconds, Pause before playing, are controls from the 3DSolutions player designed to manage playlist operations.

PlayList Select, is the window which shows the playlist of the clips which is selected. Each selected Playlist will be managed by the settings of the Tools, and checked in the first box to Save the settings, and clicked in the second box to activate the settings on the Playlist run time.

File type—same list of choices.

Declipse—opens the various Declipse settings options.

### Remote Interface

Referring to FIG. 4, this is a Remote Control interface which is similar to some of the functions to the Customer Media Player window, but designed to operate from the use of the buttons on the remote control hand held unit 67. These include FnO for custom viewing adjustments, controls for viewing distance, View Direct, crispness, brightness, contrast, screen size, stereo, 2D, 2D Plus Depth, etc.

The Remote Control Menu Window is the On Screen Display that comes up when the Depth Button is clicked on the Remote control hand unit. The Depth Button activates the Window showing the switching choices of the Automatic, Semi-automatic and Manual DCT controls. The Menu is designed to support fully automatic on-the-fly adjustments to the DCT via a feedback loop taking depth Metadata derived from the 2D Plus Depth map, by software depth mining, to create an automatic adjustment of the DCT, a semi-automatic reference point for End User fine tuning of the Automatic DCT, and finally, for a Manual DCT override adjustment which allows the viewer to be able to make Master Global, and Major DCT changes to the FnO adjustments to the video, for the purpose of watching and or Recording the 3D clip with a new XML file showing the upgrade adjustments based on the End User Manually correcting image quality issues. There are a number of options in which this control can be applied.

a) for video which is not remastered to Rembrandt 3D preset FnO data points.

b) for video which is remastered to Rembrandt 3D preset FnO data points, but to which the viewer feels that the image quality needs correction.

The first row of the window show the selection buttons for the “source” of the video signal. The source can be coming from a Side By Side stereo 3D source, an.s3D format, 2D or a Rembrandt 3D Preset (remastered) video clip with XML file data points embedded.

Second Row, is the Auto settings choices for each of the above Source selections. For SxS,.s3D. and Rembrandt 3D there are three boxes, which are preprogrammed FnO default Master Global data points, with a range of “soft/low, hard/medium and extreme/High”

Third Row, is the FnO Manual Controls—These are the Semi-automatic override FnO controls for the Master Global settings and may be tweaked by the user. They are scaled controlled by the boxes below the title showing “Standard (the base FnO range), X2 (doubles the FnO range) Divides by 2, (divides the Standard base range by 2), 3rD Row, Source Boxes—These are the selection boxes for the source of the Content, is it from a PC

“File”, or “Live” from STB, BluRay, etc. Also, there is a “Default” button which returns the adjustment to the “Standard” FnO settings.

Fourth Row, FnO Slider Controls from Display control Tool—These are the same Slider controls as seen in the other FnO slider windows, same functions, Save, numerical values come up in the boxes to the right.

The Remote Control Display is designed to give the Viewer the ability to adjust the image quality in a small amount to correct minor distortions in the 3D effect, without distorting the image to the entire clip. Consequently the operations of the Master Global FnO adjustments are limited as a range of adjustment which prevents the Viewer from making dramatic adjustments that would overdrive the image.

### Scheduler Menu

Referring to FIG. 5, the Scheduler Menu is the Window which supports the commercial application of the Media Player as a Digital Signage, Hospitality and Retail promotional 3DTV product. The Scheduler incorporates basic date, time, play, run, stop and start information to regulate and document the clips that are playing at any specific time, and provides the logs for the recording of the Ads run time, duration, time of day, and number of spots per day for the Reporting needed to supply to the Advertiser or Store owner. The design and implementation of the Schedule needs to perform certain basic and standard operations consistent with all digital signage and retail signage installations.

This window is designed to support Advertising Network applications where the time coordinated scheduling of Digital Signage Advertisements need to be regulated and managed to support the scheduling of the actual number of clips to be run and when, plus provide the reporting basis for the account information that is documented as part of the Due Diligence that the Signage operator must supply to the Advertising Client.

This R3D “Scheduler” can be based on a simple Time Clock reference point, which can be set either manually or automatically. (based on PC clock) The clock is given a number of scheduling Stop/Start options to coordinate the time that the specific Playlist will begin, on what date, and how many times it will run on that day, and at what time it will stop. The Scheduler should also provide for the insertion of additional Advertisements, and their time of placement scheduling as a “Change of Schedule”.

KEY—All of these operations need to be recorded in a log style format and Saved to a memory file which is dedicated to logging the Schedulers operations. These should include the data collected from the playlist, run times, stop and starts, insertions and all power interruptions or loss of Advertisement Playback.

First Row, the Links to the other Window of the Media Player

Second Row, left half of the screen. - This is the Wowvx Player Playlist window, with all of its normal functions, showing all of the clips to be played. Boxes clicked would control whether that clip played during the rotation. All other functions added to the

Playlist as described in earlier paragraphs are to be included here, such as the Activation dot under the Clip title.

Second Row, right half of the screen,- These are the boxes and the enter windows for the Time management of the Playlist, and or Clips. This is the clock control, the Day, Start, Stop, Run#, for each of the Playlists, or clips being selected from the Player, which is to the left of these boxes, and aligned with them.

Bottom of the Page, (Not Shown), is an access button to click on a link for “REPORTING” and a Reporting menu to be able to select data from the Logs and save it to a File which can be emailed, printed, or word processed for distribution and record keeping.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of optimizing a 3D video program using a video editing timeline software comprising a media player performing the steps of:
a) reading a video file containing the video program from a video storage device, the video file comprising at least a header and video data;
b) extracting master global adjustments from the video file;
c) playing the video program on a video display, while applying the master global adjustments to the video program;
d) displaying a timeline of the video program, the timeline comprising indicators for time markers, master global adjustments, major adjustments and minor adjustments;
e) when an operator input is received at a time in the program, performing the steps of:
i) placing a marker on the timeline representing the time in the program;
ii) accepting a major adjustment or a minor adjustment from a user; and
iii) associating the major adjustment or minor adjustment with the marker and storing the marker, the time in the program represented by the marker, and the major adjustment or minor adjustments associated with the marker as data associated with the video file;
f) playing the video program on the video display, while applying the master global adjustments and any major adjustments or minor adjustments to the video program; and
g) repeating the method from step (d).

2. The method of claim 1, further comprising the step of storing the video file in the video file storage with all of the stored data from step (e)(iii).

3. The method of claim 2, in which the stored data is stored in the video file storage as a file in XML format.

4. The method of claim 2, further comprising the steps of:
reading the stored video file containing the video program with the stored data from the video storage device;
playing the video program on a video display, while applying the master global adjustments to the video program; and
as the video program plays, when the video program time is the same as the time of a marker, applying the major adjustment or minor adjustment associated with the marker to the video program.

5. The method of claim 1, in which the master global adjustments are stored in the header of the video file.

6. The method of claim 1, further comprising the step of accepting changes to the master global adjustments from a user and storing the changes in the video file.

7. The method of claim 1, in which the master global adjustments, the major adjustments and the minor adjustments comprise at least factor and offset adjustments.

8. A method of playing a video program stored in a video file in a video storage device, the video file comprising at least a header, video data, and stored data associated with the video file comprising a plurality of markers, the time in the program represented by each marker, and major adjustment or minor adjustments associated with each marker; the method comprising the steps of:
a) reading the stored video file containing the video program with the stored data from the video storage device;
b) extracting the master global adjustments from the video file;
c) playing the video program on a video display, while applying the master global adjustments to the video program; and
d) as the video program plays, when the video program time is the same as the time of a marker, applying the major adjustment or minor adjustment associated with the marker to the video program.

9. The method of claim 8, in which the stored data is stored in the video file storage as a file in XML format.

10. The method of claim 8, in which the master global adjustments are stored in the header of the video file.

11. The method of claim 8, in which the master global adjustments, the major adjustments and the minor adjustments comprise at least factor and offset adjustments.
